(19) United States
(12) Patent Application Publication
(10) Pub. No.: US 2026/0158853 A1
(43) Pub. Date: Jun. 11, 2026

(54) VEHICLE AIR CONDITIONER

(71) Applicants: HYUNDAI MOTOR COMPANY, Seoul (KR); KIA CORPORATION, Seoul (KR)

(72) Inventors: Seung Hoon Moon, Hwaseong-si (KR); Yoon Hyung Lee, Hwaseong-si (KR); Sung Hae Park, Hwaseong-si (KR); Hui Beom Gwak, Hwaseong-si (KR); Myung Hoe Kim, Hwaseong-si (KR); Jun Sang Yoo, Hwaseong-si (KR); Won Seo Kang, Cheonan-si (KR); Hong Re Jo, Seoul (KR); Nam Hoon Kim, Cheonan-si (KR); Jun Sic Jung, Asan-si (KR)

(73) Assignees: HYUNDAI MOTOR COMPANY, Seoul (KR); KIA CORPORATION, Seoul (KR)

(21) Appl. No.: 19/270,078

(22) Filed: Jul. 15, 2025

(30) Foreign Application Priority Data
Dec. 11, 2024 (KR) 10-2024-0183245

(51) Int. Cl. B60H 1/00

(52) U.S. Cl. CPC B60H 1/00671

(57) ABSTRACT

A vehicle air conditioner includes a case having: an external air inlet and an internal air inlet; an external air door coupled to an inner side of the case and located adjacent to the external air inlet, the external air door including a seating groove; a first internal air door coupled to the inner side of the case and located adjacent to the internal air inlet, the first internal air door being configured to selectively contact the seating groove; and a linkage unit mounted on the case and coupled to the external air door and the first internal air door, the linkage unit being configured to rotate the external air door and the first internal air door in conjunction with each other, where the first internal air door is inserted into the seating groove when the first internal air door exceeds a set opening degree thereof.

### CROSS-REFERENCE TO RELATED APPLICATION

This application claims, under 35 U.S.C. § 119(a), the benefit of and priority to Korean Patent Application No. 10-2024-0183245, filed on Dec. 11, 2024, the entire contents of which are incorporated herein by reference.

### BACKGROUND

### (a) Technical Field

The present disclosure relates to a vehicle air conditioner, and more particularly, to a structure configured such that, in order to efficiently control the inflow amount of internal air and external air, a first internal air door and a second internal air door each configured to control the amount of internal air to be introduced into the vehicle interior contact an internal space of an external air door to increase the amount of internal air introduced into the vehicle interior. Through such a structural configuration, the present disclosure provides a technique for efficiently performing a control operation to mix the internal air and the external air in the vehicle air conditioner.

### (b) Background Art

In the related art, an internal air door and an external air door are installed separately in order to control the inflow of internal air and external air in a vehicle air conditioner, and a partition wall is disposed between the internal air door and the external air door to control mixing of the internal air and the external air and to form separate inflow paths. The above-described structural configuration is used to maintain air-conditioning performance and to restrict unnecessary inflow of the external air. In particular, the structural configuration performs a significant role in blocking the external air or ensuring inflow of the internal air under specific driving conditions.

However, the partition wall of the related art has a problem in that, since the partition wall limits the opening degree of the internal air door, sufficient inflow of the internal air may not be secured even if the external air door is closed and the internal air door is fully opened. In addition, air is only introduced through a fixed path due to the partition wall, leading to lack of flexibility in air-conditioning performance and deterioration in efficiency of cooling-and-heating performance. In particular, the insufficient inflow amount of the internal air frequently causes deterioration in air-conditioning performance during driving of a vehicle.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure relates to an air intake structure of a vehicle air conditioner, and more particularly, to a technique for increasing the amount of internal air introduced into the vehicle interior and improving air-conditioning efficiency by utilizing an additional door located between an internal air door and an external air door and efficiently performing a control operation to mix the internal air and the external air. In order to address the above-described problems of the related art, recently, research and development has been conducted on an air intake structure capable of flexibly controlling the air to be introduced into the vehicle interior by additionally installing a second internal air door replacing the partition wall of the related art.

The present disclosure has been made in an effort to solve the above-described problems associated with the prior art, and various aspects of the present disclosure provide a vehicle air conditioner capable of efficiently controlling the amount of internal air and external air to be introduced into the vehicle interior.

Various aspects of the present disclosure provide a vehicle air conditioner configured to efficiently control the flow of air by adjusting the opening degree of a second internal air door replacing a partition wall and to increase the amount of internal air flowing into the vehicle interior even if an external air door is closed, thereby improving cooling-and-heating efficiency and air-conditioning performance.

The various aspects of the present disclosure are not limited to the above-mentioned aspects, and other technical aspects not mentioned herein should be clearly understood by those having ordinary skill in the art to which the present disclosure pertains from the detailed description of the embodiments. Additionally, the various aspects of the present disclosure may be achieved by means and combinations thereof as indicated in the claims.

In one aspect, the present disclosure provides a vehicle air conditioner including: a case including an external air inlet and an internal air inlet; an external air door coupled to an inner side of the case and located adjacent to the external air inlet, the external air door comprising a seating groove formed in an inner side thereof; a first internal air door coupled to the inner side of the case and located adjacent to the internal air inlet, the first internal air door being configured to selectively contact the seating groove; and a linkage unit mounted on the case and configured for the external air door and the first internal air door to be coupled thereto, the linkage unit being configured to rotate the external air door and the first internal air door in conjunction with each other, wherein the first internal air door is inserted into the seating groove when an opening degree of the first internal air door exceeds a set opening degree thereof.

In an embodiment, the vehicle air conditioner may further include a second internal air door coupled to the case and located adjacent to the external air door, the second internal air door being configured to selectively contact the seating groove, wherein the second internal air door may be inserted into the seating groove when an opening degree of the second internal air door exceeds a set opening degree thereof, and the second internal air door may be rotated in conjunction with the external air door and the first internal air door through the linkage unit.

In another embodiment, the linkage unit may include a first main lever having one end coupled to the external air door, a second main lever having one end coupled to the first internal air door, the second main lever including a connecting pin located at the other end thereof, a sub-lever coupled to the connecting pin, and a third main lever having one end coupled to the second internal air door.

In still another embodiment, the vehicle air conditioner may further include a cam mounted on the case, the cam being coupled to the other end of the first main lever, the other end of the sub-lever, and the other end of the third main lever, and an actuator located on an outer side of the case, the actuator being coupled to the cam.

In yet another embodiment, the cam may include a first slot configured to guide the first main lever, a second slot configured to guide the sub-lever, and a third slot configured to guide the third main lever.

In still yet another embodiment, the first main lever may rotate the external air door in a direction toward the first internal air door while moving from one end of the first slot to the other end thereof, the sub-lever may rotate the first inner door in a direction toward the external air door while moving from one end of the second slot to the other end thereof, and the third main lever may rotate the second inner door in a direction toward the external air door while moving from one end of the third slot to the other end thereof.

In a further embodiment, while the sub-lever is moved from one end of the second slot to the other end thereof, a movement path of the connecting pin may be bent from one side to the other side.

In another further embodiment, the external air door may include a first stopper located on one of opposite sides of the external air door, the opposite sides facing the seating groove, the first stopper being configured to selectively contact the first internal air door, and a second stopper located adjacent to the first stopper, the second stopper being configured to selectively contact the second internal air door.

In still another further embodiment, the vehicle air conditioner may further include a controller configured to control, according to an internal air opening degree, an opening degree of each of the external air door, the first internal air door, and the second internal air door.

In yet another further embodiment, the controller may be configured to control, when the internal air opening degree exceeds a first setting value, the linkage unit such that the external air door closes the external air inlet.

In still yet another further embodiment, the controller may be configured to control, when the internal air opening degree corresponds to a second setting value, the linkage unit such that the first internal air door and the second internal air door are inserted into the seating groove of the external air door.

In a still further embodiment, the controller may be configured to control, when the internal air opening degree corresponds to a third setting value, the linkage unit such that the first internal air door and the first stopper contact each other.

In a yet still further embodiment, the controller may be configured to control the linkage unit such that the second internal air door and the second stopper contact each other.

Other aspects and embodiments of the disclosure are discussed below.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail below with reference to certain embodiments thereof illustrated in the accompanying drawings which are given hereinbelow by way of illustration only, and thus are not limitative of the present disclosure, and wherein:

FIG. 1 is a perspective view of a vehicle air conditioner according to an embodiment of the present disclosure;

FIG. 2A and FIG. 2B are side views of a cam according to an embodiment of the present disclosure, showing a coupling relationship between the cam and each lever;

FIG. 2C is a view showing the operating states of an external air door, a first internal air door, and a second internal air door when an internal air opening degree is 0, according to an embodiment of the present disclosure;

FIG. 3A and FIG. 3B are views showing the operating states of an external air door, a first internal air door, and a second internal air door when the internal air opening degree is a first setting value, according to an embodiment of the present disclosure;

FIGS. 4A and 4B are views showing the operating state of each of the external air door, the first internal air door, and the second internal air door when the internal air opening degree is a second setting value, according to an embodiment of the present disclosure; and

FIG. 5A and FIG. 5B are views showing the operating state and air flow of each of the external air door, the first internal air door, and the second internal air door when the internal air opening degree is a third setting value, according to an embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the disclosure is described in conjunction with certain embodiments, it should be understood that the present description is not intended to limit the disclosure to the disclosed embodiments. On the contrary, the disclosure is intended to cover not only the disclosed embodiments, but also various alternatives, modifications, equivalents, and other embodiments, which may be included within the spirit and scope of the disclosure as defined by the appended claims. The present embodiments are provided to more fully explain the disclosure to those of ordinary knowledge and skill in the art.

Terms such as “part”, “unit”, and “module” described in the specification mean a unit configured to process at least two functions or operations, and the unit may be implemented by hardware or software or a combination of hardware and software. Each “part”, “unit”, “module”, “component”, “device”, “element”, and the like may separately embody or be included with a processor and a memory, such as a non-transitory computer readable media, as part of the apparatus.

The terms used in the specification are merely used to describe specific embodiments and are not intended to limit the embodiments. Singular forms are intended to include plural forms as well, unless the context clearly indicates otherwise.

When a portion “comprises” or “includes” a certain component throughout the specification, this means that the portion may further comprise or include other components without excluding the other components unless stated otherwise. Further, terms such as “unit”, and “part” described in the specification mean a unit configured to process at least two functions or operations. When a part, component, unit, device, element, or the like of the present disclosure is described as having a purpose or performing an operation, function, or the like, the part, component, unit, device, or element should be considered herein as being “configured to” meet that purpose or to perform that operation or function.

Moreover, a controller 300 may be implemented by an algorithm configured to control the operation of various components disposed in the vehicle, a memory configured to store data about a program that reproduces the algorithm, and a processor configured to perform the above-described operation using data stored in the memory. In this case, the memory and the processor may be implemented as separate chips. Alternatively, the memory and the processor may be implemented as a single chip. The controller 300 may include at least two of an electronic control unit (ECU), a central processing unit (CPU), a microprocessor unit (MPU), a microcontroller unit (MCU), an application processor (AP), or any type of processor well known in the technical field of the present disclosure.

Furthermore, the controller 300 may be formed of a combination of software and hardware capable of performing an operation on at least two applications or programs for executing a method according to embodiments of the present disclosure.

Hereinafter, embodiments are described in detail with reference to the accompanying drawings. In describing the embodiments with reference to the accompanying drawings, the same or corresponding components are denoted by the same reference numerals and redundant description thereof has been omitted.

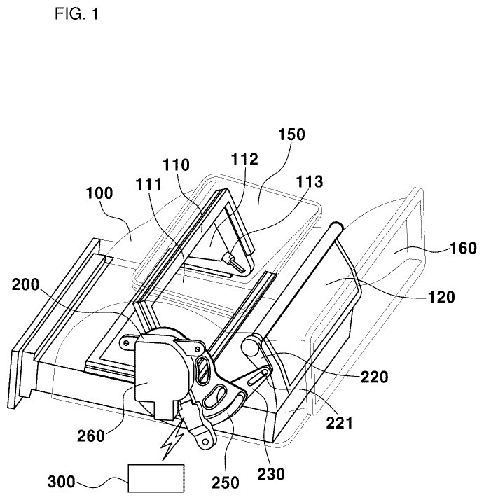

FIG. 1 is a perspective view of a vehicle air conditioner according to an embodiment of the present disclosure.

According to an embodiment of the present disclosure, the vehicle air conditioner includes a case 100 including an external air inlet 150 and an internal air inlet 160, an external air door 110 configured to open and close the external air inlet 150, a first internal air door 120 configured to open and close the internal air inlet 160, the first internal air door 120 selectively contacting the inner space of the external air door 110, and a linkage unit 200 configured to rotate the external air door 110 and the first internal air door 120 in conjunction with each other.

In addition, the vehicle air conditioner is configured to include a second internal air door 130 configured to selectively contact an internal seating groove 111 (i.e., internal channel, hollow portion or space) of the external air door 110 and the first internal air door 120. Furthermore, the vehicle air conditioner is configured to include a controller 300 configured to control, based on the internal air opening degree, the opening degree of each of the external air door 110, the first internal air door 120, and the second internal air door 130.

The case 100 includes the external air inlet 150 and the internal air inlet 160 and is configured to surround the external air door 110, the first internal air door 120, and the second internal air door 130. In other words, the external air door 110, the first internal air door 120, and the second internal air door 130 are located inside the case 100. In addition, a filter 140 is located inside the case 100. The filter 140 is located at the lower end of the external air door 110 and is configured to allow air introduced from the external air inlet 150 or the internal air inlet 160 to pass therethrough. The air introduced from the external air inlet 150 or the internal air inlet 160 flows along the inside of the case 100, passes through the filter 140, and then passes through a heat exchange unit (not shown) so as to exchange heat with the heat exchange unit (not shown). Thereafter, the air is discharged into the interior of the vehicle.

The external air door 110 opens and closes the external air inlet 150 through which air is introduced from the outside and is coupled to the inner side of the case 100. Furthermore, rotation shafts of the external air door 110 are respectively coupled to both sides of the case 100, which are adjacent to the external air inlet 150, and the external air door 110 is rotated around the rotation shafts in a direction of opening and closing the external air inlet 150.

In addition, the external air door 110 may be formed to have a dome shape with an open interior, and the upper surface of the external air door 110 may be formed to have an embossed shape.

Furthermore, the external air door 110 includes, at the inside thereof, the seating groove 111 configured for the first internal air door 120 and the second internal air door 130 to be inserted thereinto, a first stopper 112 located on one of opposite sides of the external air door 100, the opposite side facing the seating groove 111, and configured to interfere with a movement trajectory of the first internal air door 120, and a second stopper 113 located below the first stopper 112 and configured to selectively contact the second internal air door 130.

The seating groove 111 located on the inner side of the external air door 110 is configured to be surrounded by the upper surface of the external air door 110 and the opposite sides of the external air door 110. In addition, the seating groove 111 is configured to come into contact with the first internal air door 120 and the second internal air door 130 when each of the first internal air door 120 and the second internal air door 130 is rotated by a set opening degree thereof. Furthermore, when each of the first internal air door 120 and the second internal air door 130 is opened beyond the set opening degree, the first internal air door 120 and the second internal air door 130 are inserted into the seating groove 111. In this example, the set opening degree means an opening degree of each of the external air door 110, the first internal air door 120, and the second internal air door 130, which is proportional to an internal air opening degree.

The first internal air door 120, which is selectively in contact with the seating groove 111, is configured to be coupled to the inner side of the case 100 so as to open and close the internal air inlet 160. Furthermore, the first internal air door 120 has rotation shafts respectively coupled to both inner sides of the case 100, which are adjacent to the internal air inlet 160, and is rotated around the rotation shafts in a direction of opening and closing the internal air inlet 160.

In addition, the first internal air door 120 may be formed to have a flat shape. Furthermore, the first internal air door 120 is configured to be rotated around the rotation shafts in a direction of opening the internal air inlet 160, to selectively contact the second internal air door 130, or to be inserted into the seating groove 111 so as to contact the first stopper 112 depending on the internal air opening degree.

The second internal air door 130, which is configured to selectively contact the first internal air door 120, may be located between the external air door 110 and the first internal air door 120. In addition, the second internal air door 130 may be formed to have a “V” shape. Furthermore, the second internal air door 130 is coupled to both sides of the case 100 through the rotation shafts of the second internal air door 130 and is rotated around the rotation shafts in a direction toward the external air door 110 or away from the external air door 110.

In addition, the second internal air door 130 is configured, depending on the internal air opening degree, to selectively contact the first internal air door 120 or to be inserted into the seating groove 111 of the external air door 110 so as to contact the second stopper 113. In one example, a part of the second internal air door 130 having a “V” shape selectively contacts the end of the first internal air door 120 so as to block air introduced through the internal air inlet 160 from flowing to the seating groove 111. Additionally, a part of the second internal air door 130 is configured to contact the second stopper 113 so as to allow air introduced through the internal air inlet 160 to flow to the seating groove 111.

The external air door 110, the first internal air door 120, and the second internal air door 130 of the vehicle air conditioner are coupled to the linkage unit 200, and the linkage unit 200 rotates the external air door 110, the first internal air door 120, and the second internal air door 130 in conjunction with each other.

The linkage unit 200, which is configured to rotate the external air door 110, the first internal air door 120, and the second internal air door 130, includes an actuator 260 mounted on the outer surface of the case 100, a cam 250 rotated by operation of the actuator 260, a first main lever 210, a sub-lever 230, and a third main lever 240 that are coupled to the cam 250. Furthermore, the linkage unit 200 is configured to include a second main lever 220 coupled to the sub-lever 230.

The actuator 260 is mounted on the outer surface of the case 100. In addition, the actuator 260 is configured to include a driving shaft (not shown) connected to the cam 250. Furthermore, the actuator 260 is configured to rotate the cam 250 by rotation of the driving shaft (not shown).

The cam 250 rotatably coupled to the actuator 260 is coupled to the first main lever 210, the sub-lever 230, and the third main lever 240 so as to rotate the external air door 110, the first internal air door 120, and the second internal air door 130 in conjunction with each other.

In addition, the cam 250 is formed of a first slot 251 configured to guide the first main lever 210, a second slot 252 configured to guide the sub-lever 230, and a third slot 253 configured to guide the third main lever 240.

The first slot 251 is coupled to the first main lever 210 through a first pin 211 located on the first main lever 210. In addition, the first slot 251 is formed to have a shape in which the radius of the first slot gradually increases in the radial direction from a portion of the first slot, which is located closest to the center of the cam 250, to a certain portion, and then a constant radius of the first slot is maintained along the outermost edge of the cam 250. In this example, the radius means a straight distance from the center of the cam 250 to the slot.

The second slot 252 has one end located at the outermost edge of the cam 250 from the center of the cam 250 and is connected to the sub-lever 230 through a second pin 231 located on the sub-lever 230. Furthermore, the second slot 252 is formed to have a shape in which the radius of the second slot gradually decreases from the one end along the outermost edge of the cam 250.

The third slot 253, which is located closest to the center of the cam 250, is formed to have a shape in which the radius of the third slot 253 gradually increases in the radial direction from a portion of the third slot 253, which is located closest to the center of the cam 250, to a certain portion, and then, a constant radius of the third slot 253 is maintained along the inner side of the second slot 252.

The first main lever 210 coupled to the first slot 251 has one end coupled to the rotation shaft of the external air door 110. In addition, the first main lever 210 is engaged with the first slot 251 through the first pin 211 located at the other end of the first main lever 210.

The sub-lever 230 coupled to the second slot 252 has one end coupled to the second main lever 220 and is coupled to the second slot 252 through a connecting pin 231 located at the other end of the sub-lever 230. In addition, the second main lever 220 coupled to the sub-lever 230 has one end coupled to the rotation shaft of the first internal air door 120 and is coupled to the sub-lever 230 through a connecting pin 221 located at the other end of the second main lever 220. Therefore, the first internal air door 120 is rotated through the second main lever 220 and the sub-lever 230, i.e., a two-stage lever structure.

The third main lever 240 coupled to the third slot 253 has one end coupled to the rotation shaft of the second internal air 130 and is coupled to the third slot 253 through a third pin 241 located at the other end of the third main lever 240.

In this manner, the external air door 110 opens and closes the external air inlet 150 according to movement of the first main lever 210, the first internal air door 120 opens and closes the internal air inlet 160 according to movement of the sub-lever 230 linked to the second main lever 220, and the second internal air door 130 is selectively inserted into the seating groove 111 according to movement of the third main lever 240.

In addition, the opening degrees of the external air door 110, the first internal air door 120, and the second internal air door 130 are controlled by the controller 300. The controller 300 controls the linkage unit 200 according to the internal air opening degree so as to adjust the opening degrees of the external air door 110, the first internal air door 120, and the second internal air door 130.

Furthermore, the controller 300 adjusts the opening degrees of the external air door 110, the first internal air door 120, and the second internal air door 130 according to the internal air opening degree.

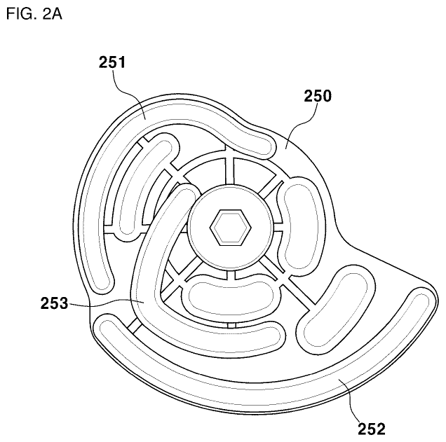

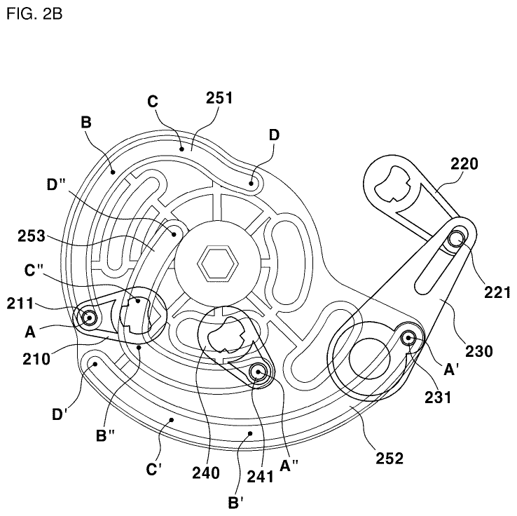

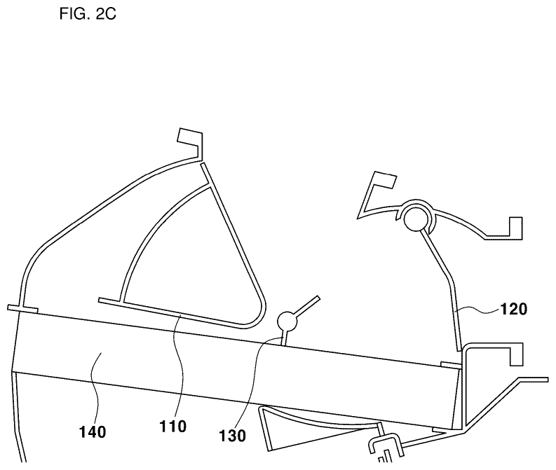

When the internal air opening degree is 0, the controller 300 controls the linkage unit 200 to open only the external air door 110 (see FIGS. 2B and 2C).

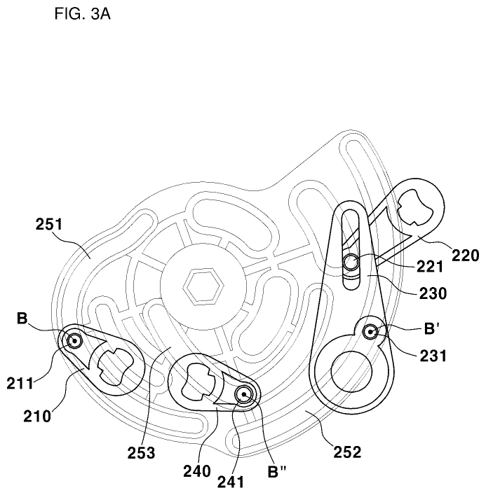

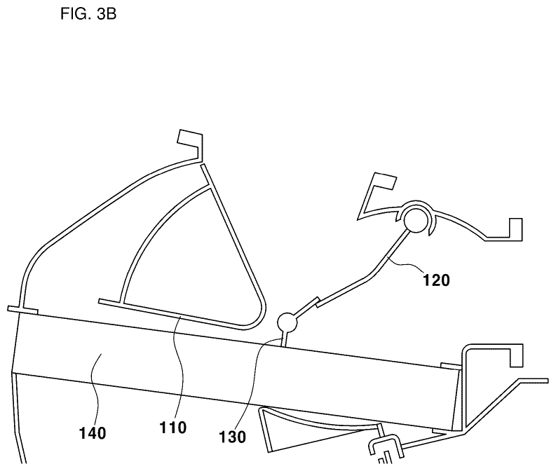

In addition, when the internal air opening degree corresponds to a first setting value stored in the controller 300, the controller 300 controls the linkage unit 200 in a direction of opening the internal air inlet 160 by the first internal air door 120. Furthermore, when the internal air opening degree corresponds to the first setting value stored in the controller 300, the controller 300 controls the linkage unit 200 such that the first internal air door 120 and the second internal air door 130 contact each other. In one example, the first setting value means an internal air opening degree at which the first internal air door 120 and the second internal air door 130 contact each other (see FIGS. 3A and 3B).

Furthermore, when the internal air opening degree exceeds the first setting value stored in the controller 300, the controller 300 controls the linkage unit 200 so as to close the external air door 110 and rotate the second internal air door 130 in a direction in which the second internal air door 130 is inserted into the seating groove 111.

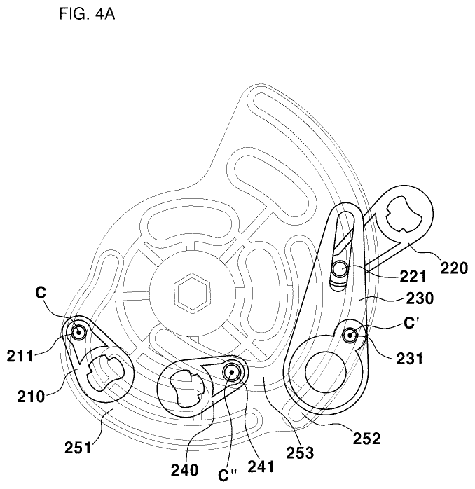

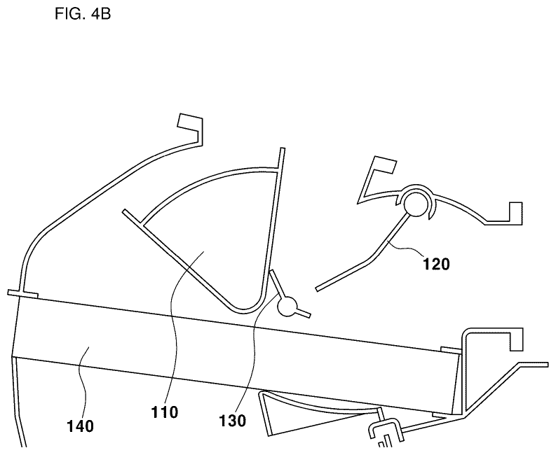

In addition, when the internal air opening degree corresponds to a second setting value stored in the controller 300, the controller 300 controls the linkage unit 200 such that at least one of the first internal air door 120 and the second internal air door 130 is inserted into the seating groove 111 (see FIGS. 4A and 4B).

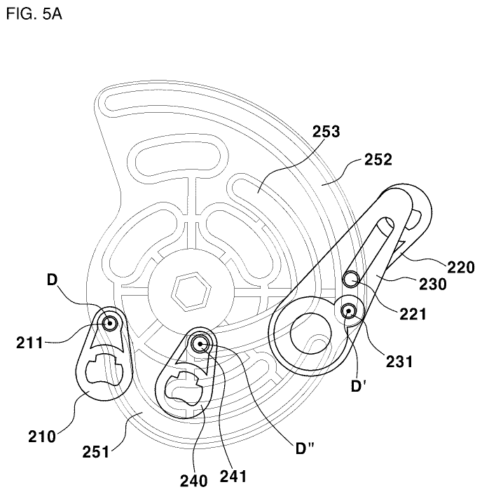

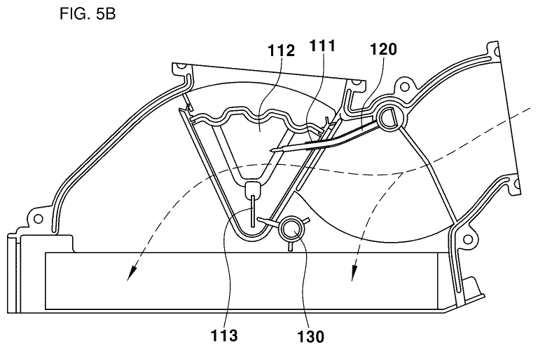

Further, when the internal and external air circulation mode is in the internal mode and the opening degree corresponds to a third setting value stored in the controller 300, the controller 300 controls the linkage unit 200 such that the first internal air door 120 and the first stopper 112 contact each other and the second internal air door 130 and the second stopper 113 contact each other (see FIGS. 5A and 5B).

In one example, the first setting value, the second setting value, and the third setting value stored in the controller 300 mean values sequentially having a large internal air opening degree.

FIG. 2A and FIG. 2B are side views of the cam 250, showing a coupling relationship between the cam 250 and each lever.

According to an embodiment of the present disclosure, the cam 250 includes the first slot 251 to which the first main lever 210 is coupled, the second slot 252 to which the sub-lever 230 is coupled, and the third slot 253 to which the third main lever 240 is coupled.

Furthermore, the cam 250 rotates the external air door 110, the first internal air door 120, and the second internal air door 130 in conjunction with the first main lever 210, the sub-lever 230, and the third main lever 240.

The first slot 251 is configured to include a point A at which the internal air opening degree is 0, a point B at which the opening degree is the first setting value, a point C at which the opening degree is the second setting value, and a point D at which the opening degree is the third setting value. In one example, the point A is located at one end of the first slot 251, and the point D is located at the other end of the first slot 251.

The opening state of the external air door 110 is determined by the position of the first pin 211 located in the first slot 251. For example, when the first pin 211 is located at the point A, the external air door 110 corresponds to a fully opened state. When the first pin 211 is located at the point B, the external air door 110 maintains the fully opened state.

In addition, when the first pin 211 is located at the point C, the external air door 110 is rotated by a certain opening degree thereof in a direction of closing the external air inlet 150. Furthermore, when the first pin 211 is located at the point D, the external air door 110 closes the external air inlet 150.

The other end of the second slot 252 is adjacent to one end of the first slot 251, and one end thereof is located at the outermost edge of the cam 250 from the center of the cam 250. The second slot 252 is formed along the outermost edge of the cam 250 in a direction toward the center of the cam 250. Furthermore, the second slot 252 is formed by extending from one end to the other end, the radius of which gradually decreases along the outermost edge of the cam 250.

In addition, the second slot 252 is configured to include a point A′ at which the internal air opening degree is 0, a point B′ at which the internal air opening degree is the first setting value, a point C′ at which the internal air opening degree is the second setting value, and a point D′ at which the internal air opening degree is the third setting value. The point A′ is located at one end of the second slot 252, and the point D′ is located at the other end of the second slot 252.

When the second pin 231 is located at the point A′, the first internal air door 120 is in a state of closing the internal air inlet 160. In addition, when the second pin 231 is located at the point B′, the first internal air door 120 contacts the second internal air door 130, and when the second pin 231 is located at the point C′, the first internal air door 120 is inserted into the seating groove 111. Furthermore, when the second pin 231 is located at the point D′, the second internal air door 130 contacts the first stopper 112.

When the second pin 231 is moved sequentially along the second slot 252 from the point A′ to the point D′, the connecting pin 221 connecting the sub-lever 230 to the second main lever 220 may be moved in a direction in which the connecting pin is bent from one side to the other side.

In one example, when the second pin 231 is located at the point A′, the sub-lever 230 and the second main lever 220 may be located to form a “¬” shape, and when the second pin 231 is moved between the points A′ and B′ or between the points B′ and C′, the sub-lever 230 and the second main lever 220 may be located on a straight line. In addition, when the second pin 231 is located at the point C′, the sub-lever 230 and the second main lever 220 may be located to form a “¬” shape.

The third slot 253 is located closest to the center of the cam 250. In addition, the third slot 253 is configured to include a point A″ at which the internal air opening degree is 0, a point B″ at which the internal air opening degree is the first setting value, a point C″ at which the internal air opening degree is the second setting value, and a point D″ at which the internal air opening degree is the third setting value. The point A″ is located at one end of the third slot 253, and the point D″ is located at the other end of the second slot 253.

When the third pin 241 is located at the point A″, the second internal air door 130 is located in contact with a part of the filter 140. In addition, when the third pin 241 is located at the point B″, the second internal air door 130 is in contact with the first internal air door 120, and when the third pin 241 is located at the point C″, the second internal air door 130 is inserted into the seating groove 111. Furthermore, when the third pin 241 is located at the point D″, the first internal air door 120 contacts the second stopper 113.

FIG. 2B and FIG. 2C are views showing the operating states of the external air door 110, the first internal air door 120, and the second internal air door 130 when the internal air opening degree is 0. FIG. 3A and FIG. 3B are views showing the operating states of the external air door 110, the first internal air door 120, and the second internal air door 130 when the internal air opening degree is the first setting value.

According to an embodiment of the present disclosure, as shown in FIGS. 2B and 2C, when the internal air opening degree is 0, the controller 300 is configured to control the opening degree of the external air door 110 so as to open the external air inlet 150, and to control the opening degree of the first internal air door 120 so as to close the internal air inlet 160.

When the internal air opening degree is 0, the controller 300 controls the cam 250 such that the first pin 211 is located at the point A, the second pin 231 is located at the point A′, and the third pin 241 is located at the point A″. When the first pin 211 is located at the point A, the external air door 110 fully opens the external air inlet 150. At the same time, when the second pin 231 is located at the point A′, the first internal air door 120 closes the internal air inlet 160, and when the third pin 241 is located at the point A″, the second internal air door 130 contacts the filter 140. In this case, only the air introduced through the external air inlet 150 may flow into the case 100.

As shown in FIGS. 3A and 3B, when the internal air opening degree corresponds to the first setting value stored in the controller 300, the controller 300 controls the cam 250 such that the first pin 211 is located at the point B, the second pin 231 is located at the point B′, and the third pin 241 is located at the point B″.

When the first pin 211 is located at the point B, the external air door 110 maintains the fully opened state of the external air inlet 150. In addition, when the second pin 231 is located at the point B′, the first internal air door 120 partially opens the internal air inlet 160. Simultaneously, when the third pin 241 is located at the point B″, the second internal air door 130 contacts the filter 140 as in the case where the third pin 241 is located at the point A″. Furthermore, when the second pin 231 is located at the point B′ and the third pin 241 is located at the point B″, the first internal air door 120 and the second internal air door 130 contact each other. In this case, the air introduced through the external air inlet 150 and the air passing through the internal air inlet 160 may be introduced into the case 100. Additionally, the air passing through the internal air inlet 160 does not flow into the seating groove 111.

FIG. 4A and FIG. 4B are views showing the operating state of the external air door 110, the first internal air door 120, and the second internal air door 130 when the internal air opening degree is the second setting value.

According to an embodiment of the present disclosure, when the internal air opening degree is the second setting value, the controller 300 adjusts the cam 250 such that the first pin 211 is located at the point C, the second pin 231 is located at the point C′, and the third pin 241 is located at the point C″.

When the first pin 211 is located at the point C, the external air door 110 is rotated by a set opening degree thereof so as to maintain the partially opened state of the external air inlet 150. In addition, when the second pin 231 is located at the point C′, the first internal air door 120 is rotated by a set opening degree thereof so as to partially open the internal air inlet 160. Further, the first internal air door 120 may be inserted into the seating groove 111.

When the third pin 241 is located at the point C″, the second internal air door 130 is rotated by a set opening degree thereof in a direction in which the second internal air door is inserted into the seating groove 111 and is separated from the filter 140. Furthermore, the second internal air door 130 may be inserted into the seating groove 111. In this case, the air introduced through the external air inlet 150 and the air passing through the internal air inlet 160 may be introduced into the case 100. In addition, a part of the air passing through the internal air inlet 160 flows into the seating groove 111 and flows into the case 100.

FIG. 5A and FIG. 5B are views showing the operating state and air flow of each of the external air door 110, the first internal air door 120, and the second internal air door 130 when the internal air opening degree is the third setting value. According to an embodiment of the present disclosure, when the internal air opening degree is the third setting value, the controller 300 adjusts the cam 250 such that the first pin 211 is located at the point D, the second pin 231 is located at the point D′, and the third pin 241 is located at the point D″.

When the first pin 211 is located at the point D, the external air door 110 is rotated by a set opening degree thereof so as to close the external air inlet 150. In addition, when the second pin 231 is located at the point D′, the first internal air door 120 is rotated by a set opening degree thereof so as to fully open the internal air inlet 160. Additionally, the first internal air door 120 contacts the first stopper 112.

When the third pin 241 is located at the point D″, the second internal air door 130 is rotated by a set opening degree thereof in a direction in which the second internal air door 130 is inserted into the seating groove 111 so as to contact the second stopper 113.

In this case, only the air passing through the internal air inlet 160 may be introduced into the case 100, and a part of the air passing through the internal air inlet 160 flows into the seating groove 111 and flows into the case 100.

In summary, the present disclosure is characterized in that the external air door 110, the first internal air door 120, and the second internal air door 130 are rotated in conjunction with each other through the linkage unit 200, the cam 250 is controlled to estimate the opening degrees of the respective air doors according to the internal air opening degree, and the first internal air door 120 and the second internal air door 130 are inserted into the seating groove 111 located inside the external air door 110 so as to allow the internal air to be introduced through the seating groove 111 even if the external air door 110 is closed.

As is apparent from the above description, the present disclosure may achieve the following effects by the configuration, combination, and use relationship described in the embodiments.

First, a vehicle air conditioner of the present disclosure adopts a second internal air door instead of a partition wall, thereby having an effect of efficiently controlling, depending on an internal air opening degree, the amount of internal air to be introduced into the vehicle interior and increasing the inflow amount of the internal air. Through this structural configuration, air-conditioning performance of the vehicle may be improved, and cooling-and-heating efficiency may be significantly improved.

Second, a first internal air door and a second internal air door are configured to contact the internal space of an external air door so as to ensure that a sufficient amount of internal air flows into the vehicle interior even if the external air door is closed, thereby having an effect of increasing efficiency of an air-conditioning system and enabling stable operation of the air-conditioning system under various environmental conditions.

Third, since the external air door, the first internal air door, and the second internal air door are configured to be rotated in conjunction with each other through a linkage unit, it is possible to adjust, using a simple structural configuration, the mixing ratio of the internal air and the external air without a complex control system, thereby having an effect of reducing system design and manufacturing costs.

The present disclosure has been described in detail with reference to embodiments thereof, and the present disclosure may be used in various other combinations, modifications, and environments. In other words, it should be appreciated by those having ordinary skill in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A vehicle air conditioner comprising:
a case comprising an external air inlet and an internal air inlet;
an external air door coupled to an inner side of the case and located adjacent to the external air inlet, the external air door comprising a seating groove formed in an inner side thereof;
a first internal air door coupled to the inner side of the case and located adjacent to the internal air inlet, the first internal air door being configured to selectively contact the seating groove; and
a linkage unit mounted on the case and configured for the external air door and the first internal air door to be coupled thereto, the linkage unit being configured to rotate the external air door and the first internal air door in conjunction with each other,
wherein the first internal air door is inserted into the seating groove based on an opening degree of the first internal air door exceeding a set opening degree thereof.

2. The vehicle air conditioner of claim 1, further comprising a second internal air door coupled to the case and located adjacent to the external air door, the second internal air door being configured to selectively contact the seating groove,
wherein the second internal air door is configured to be inserted into the seating groove based on an opening degree of the second internal air door exceeding a set opening degree thereof, and
wherein the second internal air door is configured to be rotated in conjunction with the external air door and the first internal air door through the linkage unit.

3. The vehicle air conditioner of claim 2, wherein the linkage unit comprises:
a first main lever having a first end coupled to the external air door;
a second main lever having a first end coupled to the first internal air door, the second main lever comprising a connecting pin located at a second end of the second main lever;
a sub-lever coupled to the connecting pin at a first end of the sub-lever; and
a third main lever having a first end coupled to the second internal air door.

4. The vehicle air conditioner of claim 3, further comprising:
a cam mounted on the case, the cam being coupled to a second end of the first main lever, a second end of the sub-lever, and a second end of the third main lever; and
an actuator located on an outer side of the case, the actuator being coupled to the cam.

5. The vehicle air conditioner of claim 4, wherein the cam comprises:
a first slot configured to guide the first main lever;
a second slot configured to guide the sub-lever; and
a third slot configured to guide the third main lever.

6. The vehicle air conditioner of claim 5, wherein:
the first slot comprises a first point where an internal air opening degree is configured to be 0, a second point where the internal air opening degree is configured to be a first setting value, a third point where the internal air opening degree is configured to be a second setting value, and a fourth point where the internal air opening degree is configured to be a third setting value;
the second slot comprises a first point where the internal air opening degree is configured to be 0, a second point where the internal air opening degree is configured to be the first setting value, a third point where the internal air opening degree is configured to be the second setting value, and a fourth point where the internal air opening degree is configured to be the third setting value; and
the third slot comprises a first point where the internal air opening degree is configured to be 0, a second point where the internal air opening degree is configured to be the first setting value, a third point where the internal air opening degree is configured to be the second setting value, and a fourth point where the internal air opening degree is configured to be the third setting value.

7. The vehicle air conditioner of claim 6, wherein:
when a first pin located on the first main lever is located at the first point and the second point of the first slot, the external air door is fully opened, when the first pin is located at the third point of the first slot, the external air door is rotated by a predetermined opening degree in a direction of closing the external air inlet, and when the first pin is located at the fourth point of the first slot, the external air door is closed;
when a second pin located on the sub-lever is located at the first point of the second slot, the first internal air door is closed, when the second pin is located at the second point of the second slot, the first internal air door contacts the second internal air door, when the second pin is located at the third point of the second slot, the first internal air door is inserted into the seating groove, and when the second pin is located at the fourth point of the second slot, the first internal air door is fully opened; and
when a third pin located on the third main lever is located at the first point and the second point of the third slot, the second internal air door partially contacts a filter, when the third pin is located at the third point of the third slot, the second internal air door is inserted into the seating groove, and when the third pin is located at the fourth point of the third slot, the second internal air door is located closest to the external air door.

8. The vehicle air conditioner of claim 7, wherein, while the sub-lever is moved from one end of the second slot to the other end thereof, a movement path of the connecting pin is bent from one side to the other side.

9. The vehicle air conditioner of claim 2, wherein the external air door comprises:
a first stopper located on one of opposite sides of the external air door, the opposite sides facing the seating groove, the first stopper being configured to selectively contact the first internal air door; and
a second stopper located adjacent to the first stopper, the second stopper being configured to selectively contact the second internal air door.

10. The vehicle air conditioner of claim 9, further comprising a controller configured to control, according to an internal air opening degree, an opening degree of each of the external air door, the first internal air door, and the second internal air door.

11. The vehicle air conditioner of claim 10, wherein the controller is configured to control, based on the internal air opening degree exceeding a first setting value, the linkage unit such that the external air door closes the external air inlet.

12. The vehicle air conditioner of claim 10, wherein the controller is configured to control, based on the internal air opening degree corresponding to a second setting value, the linkage unit such that the first internal air door and the second internal air door are inserted into the seating groove of the external air door.

13. The vehicle air conditioner of claim 10, wherein the controller is configured to control, based on the internal air opening degree corresponding to a third setting value, the linkage unit such that the first internal air door and the first stopper contact each other.

14. The vehicle air conditioner of claim 13, wherein the controller is configured to control the linkage unit such that the second internal air door and the second stopper contact each other.
